(19) United States
(12) Patent Application Publication
(10) Pub. No.: US 2002/0009236 A1
(43) Pub. Date: Jan. 24, 2002

(54) Image data conversion device and image data conversion method for converting the order of pixels

(75) Inventor: Tadashi Sakamoto, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/845,491

(22) Filed: May 1, 2001

(30) Foreign Application Priority Data
Jul. 19, 2000 (JP) 2000-218477 (P)

(51) Int. Cl. G06K 9/36

(52) U.S. Cl. 382/246

(57) ABSTRACT

In an image data conversion device which converts image data comprising pixels of M columns (M is a positive integer) in the horizontal direction * N rows N is a positive integer) in the vertical direction, the image data are the first one dimensional data wherein pixels for M columns continuing in the horizontal direction are repeated N times in sequence in the vertical direction, and the image data conversion device includes a line memory for storing the first one dimensional data, a detection circuit connected to the line memory for detecting the pixel number M in the horizontal direction of the first one dimensional data and a conversion circuit for converting the first one dimensional data into the second one dimensional data wherein each pixel of the first one dimensional data is arranged in the order in accordance with M.

### BACKGROUND OF THE INVENTION

1. Field of the Invention

The present invention relates to a technology for outputting two dimensional image data comprising a substantial amount of pixel data and, in particular, to a technology for outputting pixel data in a different order from the recorded order.

2. Description of the Background Art

Together with the recent increase of digital cameras, the number of opportunities where a digital camera is connected to a computer, so that a printer connected to the computer prints out the image taken by the digital camera, has been increasing. In addition, the number of opportunities wherein a digital camera is connected to a printer dedicated to a digital camera, so that the images taken by the digital camera are printed by the printer without using a computer, has been increasing. In either case, within the image data transmitted from a digital camera, pieces of data for respective pixels are arranged in the order where horizontal lines of pixels, each one of which is an arrangement of pixels from left to right, are arranged from top to bottom as shown in FIG. 1. In the case that an image is printed out based on such image data the pieces of data arranged in the above described pixel order are transmitted to a printer so that the printing head of the printer scans the paper in the direction as shown in FIG. 2 and, thereby, the image is printed out.

Owing to the size limitations of the printing paper and limitations to the scanning direction of the printing head, however, there are some cases where it is desirable that an image be printed out by making the printing head scan the vertical lines of pixels, each one of which is an arrangement of pixels from top to bottom, in the arrangement order of from left to right as shown in FIG. 3. In this case, when some image data is received in the pixel order as shown in FIG. 1, all the received image data are once stored in a memory, which is referred to as a frame memory or a page memory. Vertical lines of pixels, each one of which is an arrangement of pixels from top to bottom, are transmitted to the printer in the arrangement order of from left to right. The transmission of the image data to the printer in this manner requires a large capacity of the frame memory.

Besides, in the case that image data transmitted from a digital camera is compressed according to the JPEG (Joint Photographic Experts Group) system, or the like, all of the compressed data are once expanded and stored in a frame memory and, then, vertical lines of pixel data, each one of which is an arrangement of pixels from top to bottom, are transmitted to the printer in the arrangement order of from left to right. In the case that the image data are transmitted to a printer in this manner, time for expanding all of the pixel data before the transmission to the printer is required, in addition to the requirements for a large capacity of the frame memory.

On the other hand, the Japanese Patent Laying-Open No. 8-317225 discloses an image data compression and expansion device for the purpose of outputting a rotated data of an image at high speed for compressed image data.

In the device disclosed in this gazette, image data for one page is divided into a plural number of rectangular blocks, each of which includes n pixels by n pixels, so that a compression code is generated by handling each of the divided rectangular blocks as a unit. This device includes a compression code buffer for storing compression codes for respective rectangular blocks, a compression code table for storing addresses wherein respective compression codes are stored in the compression code buffer corresponding to block numbers specifying respective rectangular blocks, an expansion circuit for reading out an address based on a specified block number stored in the compression code table so that the compression code stored in the compression code buffer is read out based on that read-out address in order to be expanded, and an output circuit for outputting image data wherein pieces of expansion data are rearranged in accordance with block position information for rectangular blocks.

According to the device disclosed in this gazette, the process of reading out, only, necessary compression codes for expansion becomes possible and the output of a rotational image, or the like, can be carried out at high speed.

In the device disclosed in the above gazette, however, a compression code table which stores the address of each compression code in the compression code buffer is required. Therefore, this device cannot be applied to compression image data which don't have a table storing addresses of all such compression codes.

### SUMMARY OF THE INVENTION

An object of the present invention is to provide an image data conversion device and an image data conversion method which do not need a large capacity of memory and which can convert the arrangement of pixels included in image data so as to be outputted.

Another object of the present invention is to provide an image data conversion device and an image data conversion method which can convert the arrangement of pixels included in image data so as to be outputted based on the structure of the pixels of the image data.

Still another object of the present invention is to provide an image data conversion device and an image data conversion method which do not need to store data representing the positions of the compressed codes, on the image, for compressed image data and which can convert the arrangement of pixels included in image data so as to be outputted.

Still another object of the present invention is to provide an image data conversion device and an image data conversion method which can convert the arrangement of pixels included in image data at high speed for compressed image data so as to be outputted.

Still another object of the present invention is to provide an image data conversion device and an image data conversion method which can convert the arrangement of pixels included in image data at high speed for compressed image data so as to be outputted by using data for compression and expansion which are attached to the compressed image data.

An image data conversion device according to the present invention is an image data conversion device which converts image data comprising pixels of M columns (M is a positive integer) in the horizontal direction by N rows (N is a positive integer) in the vertical direction, wherein the image data are first one dimensional data which include data gained by repeating pixel data for M columns, which continue in the horizontal direction, N times in sequence in the vertical direction, and the image data conversion device includes a line memory which stores the first one dimensional data, a detection circuit which is connected to the line memory and which detects the number M of pixels in the horizontal direction of the first one dimensional data which are stored in the line memory and a conversion circuit which is connected to the line memory and the detection circuit and which reads out, in the order related to the M and, thereby, converts each pixel of the first one dimensional data stored in the line memory into a second one dimensional data.

The data gained by repeating pixel data for M columns which continues in the horizontal direction N times in sequence in the vertical direction can be converted to the data which is gained by repeating pixel data for N columns which continues in the vertical direction M times in sequence in the horizontal direction by utilizing a line memory instead of utilizing a frame memory.

An image data conversion device according to another aspect of this invention is an image data conversion device which converts image data comprising pixels of M columns (M is a positive integer) in the horizontal direction by N rows (N is a positive integer) in the vertical direction, wherein: the pixel data are divided into data blocks of M/P columns (P is a positive integer and P is a divisor of M) in the horizontal direction and N/R rows (R is a positive integer and R is a divisor of N) in the vertical direction and the pixel data included in the divided data blocks are compressed into variable length code data; the image data are first one dimensional data which include a plurality of pieces of the variable length code data, data representing the number M of pixels in the horizontal direction and data representing the number P of pixels in the horizontal direction of the data blocks; the variable length code data are arranged in the order corresponding to the order of the data blocks when the data blocks are arranged in the line-sequential prioritizing the rows, and the image data conversion device includes a detection circuit for detecting data representing the number M of pixels in the horizontal direction and data representing the number P of pixels in the horizontal direction of the data blocks from the first one dimensional data, a decoding circuit which is connected to the detection circuit and which reads out variable length code data, corresponding to a plurality of data blocks existing in the positions defined based on (M/P) having a predetermined data block in the first one dimensional data as the reference, from the first one dimensional data in sequence so as to be decoded, an output circuit which is connected to the decoding circuit and which outputs, in sequence, pixel data for one column in the vertical direction which are decoded by the decoding circuit and a control circuit which is connected to the decoding circuit and which makes the decoding circuit carry out repeatedly the process of converting the positions of the predetermined data blocks in accordance with a preset order so as to read out the variable length code data.

Here, the line-sequential prioritizing rows in the first one dimensional data is defined as the order of repeating (M/P) blocks, which continues in the direction of from left to right, (N/R) times in sequence in the direction of from top to bottom. For example, variable length code data corresponding to a plurality of data blacks which exist in the positions at a distance of a multiple of (M/P) away from a predetermined data block in the first one dimensional data are read out from the first dimensional data (N/R) times so as to be decoded. A process of reading out in sequence the positions of predetermined data blocks by shifting one by one so as to be decoded is repeated (M/P) times. Thereby, the data gained by repeating pixel data for M columns which continues in the horizontal direction N times in sequence in the vertical direction are converted to the data gained by repeating pixel data for N rows which continues in the vertical direction M times in sequence in the horizontal direction in image data which are divided into data blocks of M/P columns in the horizontal direction and N/R rows in the vertical direction so as to be compressed.

More preferably, the image data further include markers provided for each specific number of data blocks and the decoding circuit includes a circuit for specifying the predetermined data blocks by using the markers.

The number of data blocks which exist between markers is known in advance and therefore, the variable length code data corresponding to the data blocks at the positions at a distance of a multiple of (M/P) can, for example, be read out in sequence so as to be decoded without determining the number of data blocks included between those markers.

More preferably, the first one dimensional data further include position information representing the positions of (N/R) data blocks which include the leading data of each row for every R rows in the first one dimensional data, the detection circuit includes a circuit for detecting position information, and the data conversion device further includes (N/R) buffers, wherein each of the (N/R) buffers has a capacity for storing variable length code data corresponding to at least one data block, and a buffer control circuit which is connected to each of the (N/R) buffers and the decoding circuit and which controls the buffer and the decoding circuit so as to read out variable length code data corresponding to the data blocks continuing in the vertical direction based on the position information from the dimensional data in order to be stored in one buffer among the (N/R) buffers corresponding to the read out variable length code data and at the same time carries out repeatedly the process of transferring variable length code data stored in another buffer to the decoding circuit.

The first one dimensional data for each data block in the vertical direction can be stored in the buffer while variable length code data stored in another buffer can be decoded. As for two different rows of one column, variable length code corresponding to data block in one row can be stored in the buffer while variable length code corresponding to the data block in the other row can be decoded. As a result, an image data conversion device which can convert the arrangement of pixels, included in the first one dimensional data, at high speed so as to be outputted by using buffers of a small capacity just for storing variable length code data corresponding to at least one data block can be provided.

An image data conversion method according to another aspect of the present invention is an image data conversion method for converting image data comprising pixels of M columns (M is a positive integer) in the horizontal direction by N rows (N is a positive integer) in the vertical direction, wherein the pixel data is divided into data blocks of M/P columns (P is a positive integer and P is a divisor of M) in the horizontal direction and N/R rows (R is a positive integer and R is a divisor of N) in the vertical direction, and the pixel data included in the divided data blocks are compressed into variable length code data, the image data are first one dimensional data which include a plurality of pieces of variable length code data, data representing the number M of pixels in the horizontal direction and data representing the number P of pixels in the horizontal direction of the data blocks, the variable length code data are arranged in the order corresponding to the order of the data blocks when the data blocks are arranged in the line-sequential prioritizing rows, and the image data conversion method includes the step of detecting data representing the number M of pixels in the horizontal direction, the data representing the number P of pixels in the horizontal data block from the first one dimensional data, the step of reading out, in sequence, variable length code data, corresponding to a plurality of the data blocks which exist at the positions defined based on (M/P) having a predetermined data block as the reference in the first one dimensional data, from the first one dimensional data so as to be decoded, the step of outputting, in sequence, the pixel data for one column in the vertical direction decoded in the step of decoding variable length code data, the step of decoding variable length code data while converting the positions of the predetermined data blocks according to a preset order and the step of repeating the step of outputting.

Variable length code data corresponding to a plurality of data blocks which exist at the positions at a distance of a multiple of (M/P) away from a predetermined data block as the reference in the first one dimensional data are read out (N/R) times from the first one dimensional data so as to be decoded. A process of reading out, in sequence, the positions of predetermined data blocks by shifting one by one so as to be decoded is repeated (M/P) times. Thereby, the data gained by repeating pixel data for M columns, which continue in the horizontal direction, N times in sequence in the vertical direction are converted to the data gained by repeating pixel data for N rows, which continue in the vertical direction, M times in sequence in the horizontal direction in the image data which have been divided into data blocks of M/P columns in the horizontal direction and N/R rows in the vertical direction so as to be compressed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram drawing the arrangement of pixel data in received image data;

FIGS. 2 and 3 are the diagrams drawing the scanning direction of the printing head in the case of printing image data;

FIG. 4 is a control block diagram of an image data conversion device according to the first embodiment of the present invention;

FIG. 5 is a diagram drawing the arrangement of pixels in an image according to the first embodiment of the present invention;

FIG. 6 is a diagram drawing the contents of image data according to the first embodiment of the present invention;

FIG. 7 is a flowchart showing the control flow of an image data conversion process according to the first embodiment of the present invention;

FIG. 8 is a control block diagram of an image data conversion device according to the second embodiment of the present invention;

FIG. 9 is a diagram drawing the arrangement of data blocks in an image according to the second embodiment of the present invention;

FIG. 10 is a diagram drawing the arrangement of pixels in a data block according to the second embodiment of the present invention;

FIG. 11 is a diagram drawing the contents of image data according to the second embodiment of the present invention;

FIG. 12 is a flowchart showing the control flow (1) of an image data conversion process according to the second embodiment of the present invention;

FIG. 13 is a diagram drawing a position table which stores data representing the positions of data blocks according to the second embodiment of the present invention;

FIG. 14 is a flowchart showing the control flow (2) of an image data conversion process according to the second embodiment of the present invention;

FIG. 15 is a control block diagram of an image data conversion process according to the third embodiment of the present invention;

FIG. 16 is a flowchart showing a control flow of an image data conversion process according to the third embodiment of the present invention;

FIG. 17 is a diagram drawing the contents of image data according to the third embodiment of the present invention;

FIG. 18 is a flowchart showing the control flow of an image data conversion process according to the fourth embodiment of the present invention;

FIG. 19 is a control block diagram of an image data conversion process according to the fifth embodiment of the present invention;

FIG. 20 is a diagram drawing the contents of image data according to the fifth embodiment of the present invention;

FIG. 21 is a diagram for describing an input data buffer according to the fifth embodiment of the present invention; and

FIG. 22 is a diagram for describing a data storing timing to an input data buffer according to the fifth embodiment of the present invention.

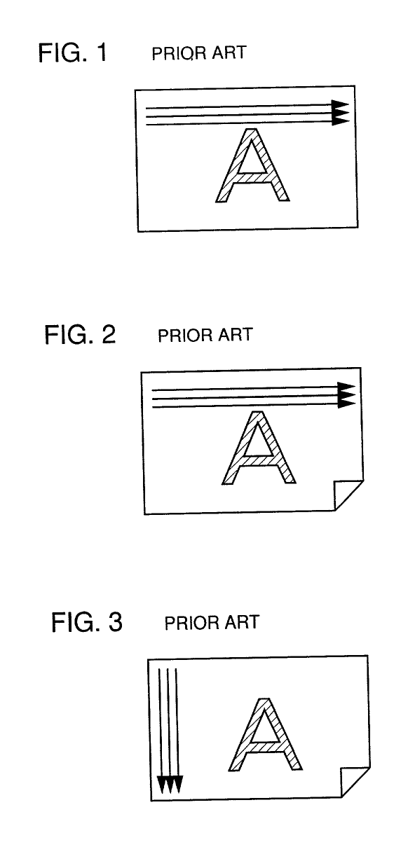

### DESCRIPTION OF THE PREFERRED EMBODIMENTS

In the following, the embodiments of the present invention are described in reference to the drawings. The same numerals are attached to the same structures in the following description and drawings. Those names and the functions are the same. Therefore, the detailed descriptions thereof will not be repeated where appropriate.

### First Embodiment

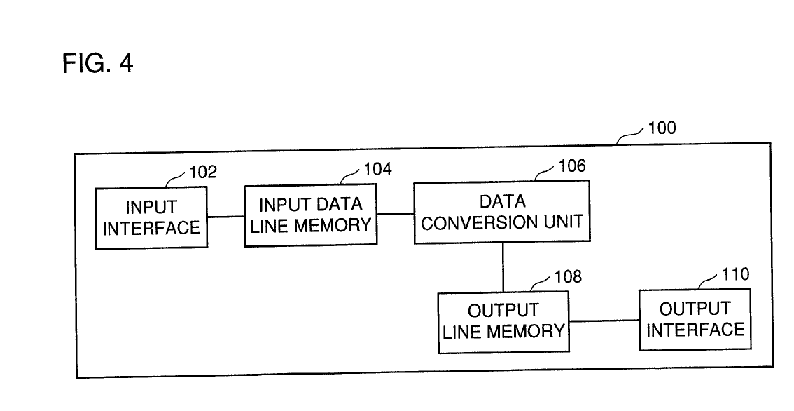

Referring to FIG. 4, a data conversion device 100 according to the present embodiment includes an input interface 102 connected to a memory card or the like of a digital camera, an input line memory 104, which is connected to the input interface 102 and which temporally stores inputted data, a data conversion unit 106, which is connected to the input line memory 104 and which converts the inputted image data, an output line memory 108, which is connected to the data conversion unit 106 and which temporally stores converted data, and an output interface 110, connected to the output memory 108, for outputting converted data to a printer or the like.

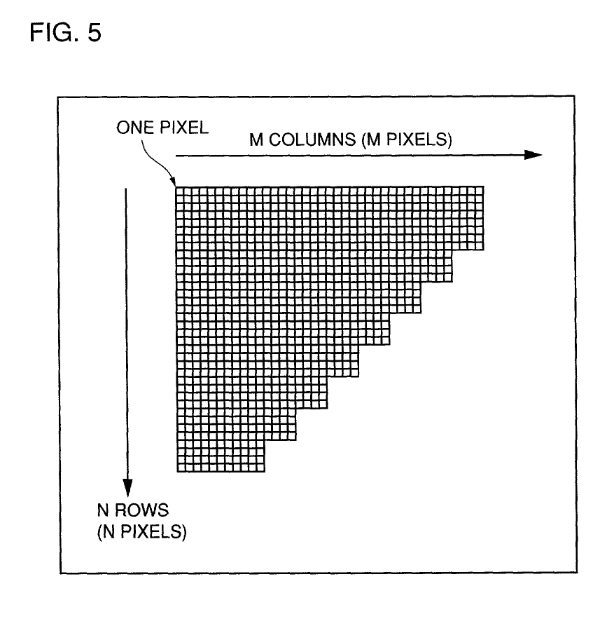

Referring to FIG. 5, image data inputted to the data conversion device 100 according to the present invention are image data of pixel number M in the horizontal direction and pixel number N in the vertical direction. In the case of a color image each pixel has, for example, data of 8 bits for RGB, respectively, that is, 24 bits in total, arranged in M columns by N rows. Accordingly, the data amount of one image becomes (M by N by 24) bits.

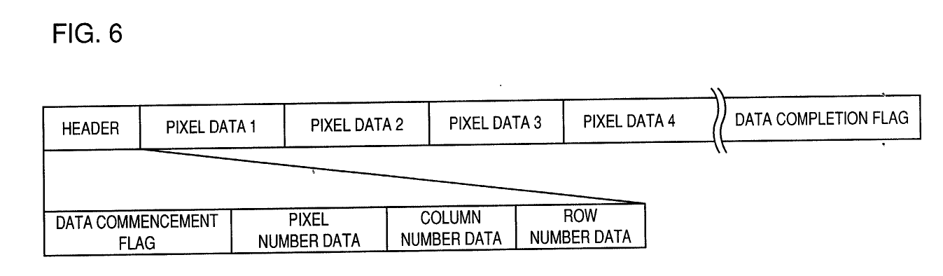

Referring to FIG. 6, image data inputted from the input interface 102 include the header, the first pixel data, the second pixel data, the third pixel data, the fourth pixel data and the data completion flag. In the following description, image data such as the first image data, the second image data, the third image data or the fourth image data are all assumed to be data of 24 bits. The header includes the data commencement flag, the image number data, the column number data and the row number data. The capacity of the header is assumed to be A bits. The commencement position of the header is assumed to be 0 bits in the image data, as shown in FIG. 6.

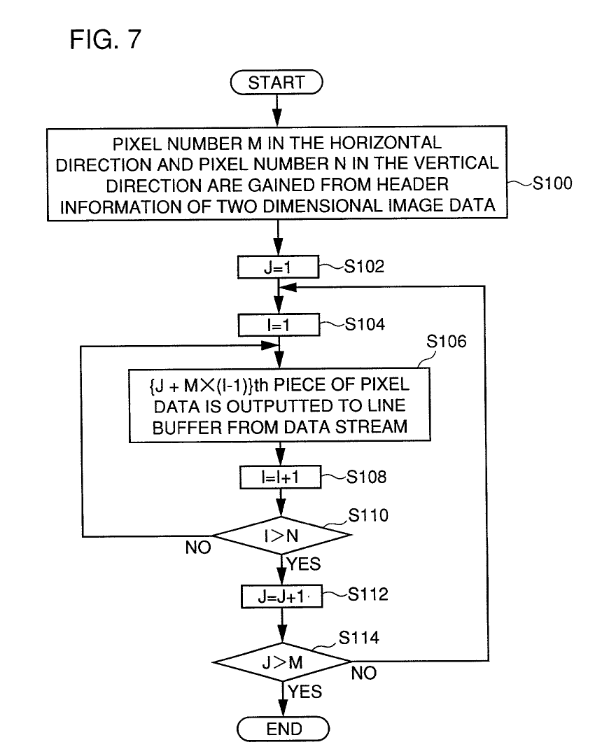

Referring to FIG. 7, the program which is implemented in the data conversion device 100 relates to the data conversion process, which has the control structure as follows.

At Step 100 (hereinafter “step” is abbreviated as “S”), the data conversion unit 106 gains the pixel number M in the horizontal direction and the pixel number N in the vertical direction from the header information of the two dimensional image data which are inputted via the input interface 102 and stored in the input line memory 104. Here, the pixel number M in the horizontal direction corresponds to the column number data in FIG. 6 and the pixel number N in the vertical direction corresponds to the row number data in FIG. 6, respectively.

The data conversion unit 106 initializes the variable J (J=1) at S102. The data conversion unit 106 initializes the variable I (I=1) at S104.

The data conversion unit 106 outputs {J+M * (I−i)}th pixel data from the image data stored in the input line memory 104 to the output line memory 108 at S106. In this case, data of 24 bits are outputted to the line memory 108 from the position gained by adding {J+M * (I−1)} * 24 bits to the bit number A of the header part as shown in FIG. 6.

The data conversion unit 106 carries out an operation of I=I+1 for variable I at S108. The data conversion unit 106 determines whether or not I>N at S110. In the case that the variable I is larger than the pixel number N in the vertical direction (YES at S110), the process moves to S112. On the other hand, in the case that the variable I is the pixel number N in the vertical direction or less (NO at S112), the process returns to S106.

The data conversion unit 106 carries out an operation of J=J+1 for the variable J at S112. The data conversion unit 106 determines whether or not J>M at S114. In the case that the variable J is larger than the pixel number M in the horizontal direction (YES at S114), the process is completed. On the other hand, in the case that the variable J is the pixel number M in the horizontal direction or less (NO at S114), the process returns to S104.

The operation of the data conversion device is described based on the above described structure and a flowchart. A memory card of a digital camera, or the like, is connected to the input interface 102 and image data as shown in FIG. 6 are stored in the input line memory 104. Data of 24 bits are outputted in sequence to output line memory from the position gained by adding {J+M * (I−1)} * 24 bits to the bit number A of the header part in the stored image data (S106). Such a process is repeated until the variable I exceeds the pixel number N in the vertical direction (YES at S110) or the variable J exceeds the pixel number N in the vertical direction (YES at S114). Asia result, the image data gained by repeating pixel data for M columns in the horizontal direction N times in the vertical direction are converted to image data gained by repeating pixel data for N rows in the vertical direction M times in the horizontal direction.

As described above, an image data conversion device according to the present invention can generate conversion data wherein rows and columns of the image are switched based on one dimensional data representing the two dimensional image by using a line memory. As a result, it becomes possible to provide an image data conversion device which does not need a high capacity frame memory and which can convert the arrangement of the pixels included in the first dimensional data representing the second dimensional image data so as to be outputted.

### Second Embodiment

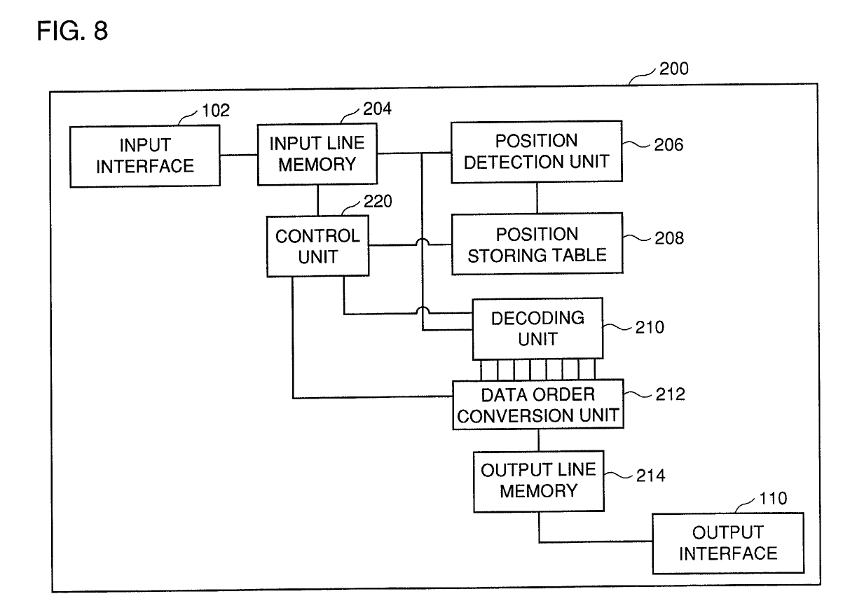

Referring to FIG. 8, an image data conversion device 200 according to the present invention includes an input interface 102, an input line memory 204 connected to the input interface 102, a position detection unit 206, which is connected to the input line memory 204 and which detects the positions of the data blocks which include the leading pixel of each row from variable length code data stored in the input line memory 204, a position storing table 208, which is connected to the position detecting unit 206 and which stores position information of data blocks which include the leading pixel of each row detected by the position detection unit 206, a control unit 220, which controls the entirety of this image data conversion device 200, a decoding unit 210, which is connected to the control unit 220 and input line memory 204 and which decodes variable length code data stored in the input line memory 204, a data order conversion unit 212 which is connected to the coding unit 210 and the control unit 220 and which converts the order of the data decoded by the decoding unit 210, an output line memory 214, which is connected to the data order conversion unit 212 and which outputs which stores temporally the converted data and an output interface 110 connected to the output line memory 214, for outputting converted data to a printer or the like. The data order conversion unit 212 includes (N/BL) two dimensional memory of BL columns in the horizontal direction by BL rows in the vertical direction. Here, the input interface 102 and the output interface 110 are the same as those of the above described first embodiment, of which the detailed description will not be repeated here.

Image data inputted into the input interface 102 of the image data conversion device 200 according to the present embodiment is described below. Image data inputted to the image data conversion device 200 according to the present embodiment are the image data compressed through the JPEG system.

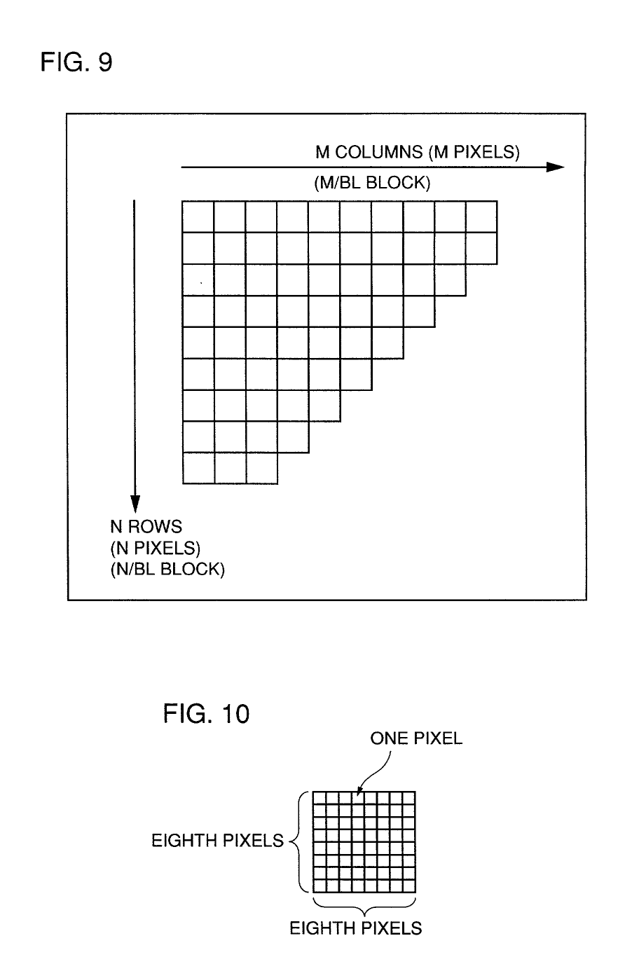

As shown in FIG. 9, the image of M columns in the horizontal direction by N rows in the vertical direction is divided into data blocks of BL pixels each in the horizontal and vertical directions so as to be compressed. As shown in FIG. 9, M pixels in the horizontal direction is divided into (M/BL) blocks. And N pixels in the vertical direction is divided into (N/BL) blocks. In the JPEG system it is divided into blocks of 8 pixels by 8 pixels (BL=8). Accordingly, for example, in the case of image data comprising pixels of 400 * 320, it is divided into 1600 data blocks, in total, of 50 blocks in the horizontal direction and 32 blocks in the vertical direction.

As shown in FIG. 10, each of these 1600 data blocks include pixel data for 64 pixels of 8 pixels by 8 pixels. In the case of a color image, one pixel has, for example, data of 24 bits, in total, of 8 bits each for RGB, respectively. Pixel data included in each of these divided data blocks are compressed so as to be variable length code data.

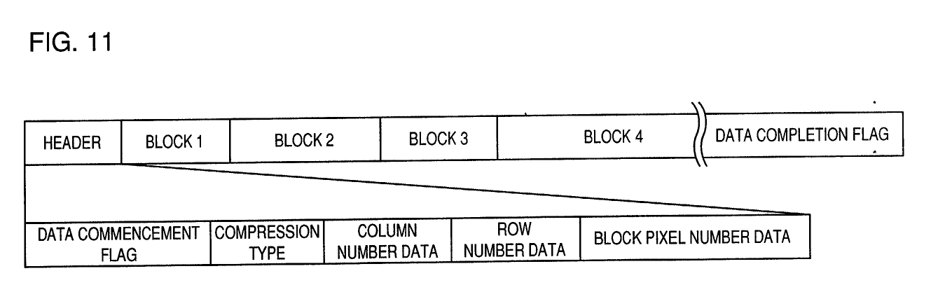

As shown in FIG. 11, variable length code data include the header, the first block which is variable length code data for each data block, the second block, the third block, the fourth block and data completion flag. The header includes the data commencement flag, data indicating a compression system, column number data, row number data and block pixel number data. The data length of variable length code data corresponding to each block is not a constant length. In the variable length code data as shown in FIG. 11, the commencement position of the header is assumed to be 0 bits.

The input line memory, 204 temporarily stores variable length code data as shown in FIG. 11. The position detection unit 206 detects the bit number from the lead of the image data (including the header) which is the position of the data block which includes the leading pixel in each row.

The position storing table stores the position of the data block detected by the position detection unit 206.

The control unit 220 reads out variable length code data which are stored in the input line memory 204 based on the position of the data block stored in the position storing table 208 so as to be transmitted to the decoding unit 210.

The decoding unit 210 decodes variable length code data inputted from the input line memory 204. The data order conversion unit 212 converts the order of the pixel data decoded by the decoding unit 210 based on the control signal from the control unit 220.

The output line memory 214 temporarily stores image data converted by the data order conversion unit 212. The data order conversion unit 212 includes a plurality of two dimensional memories. These two dimensional memories can store the (BL * BL) pieces of data. The number of these two dimensional memories are defined by the pixel number N in the vertical direction and the block pixel number BL and becomes (N/BL) pieces. For example, in the case that the pixel number in the vertical direction N=320 and the block pixel number BL=8, the number of two dimensional memories (two dimensional memories which can store pixel data of 8 * 8 pieces) included in the data order conversion unit 212 becomes 40.

The image data conversion device 200, according to the present embodiment, carries out a position detection process for detecting the positions of data blocks which include the leading pixel for each row with respect to variable length code data inputted from the input interface 102 and image data decoding process for outputting image data to the line memory by decoding data blocks in a predetermined order based on the positions of detected data blocks.

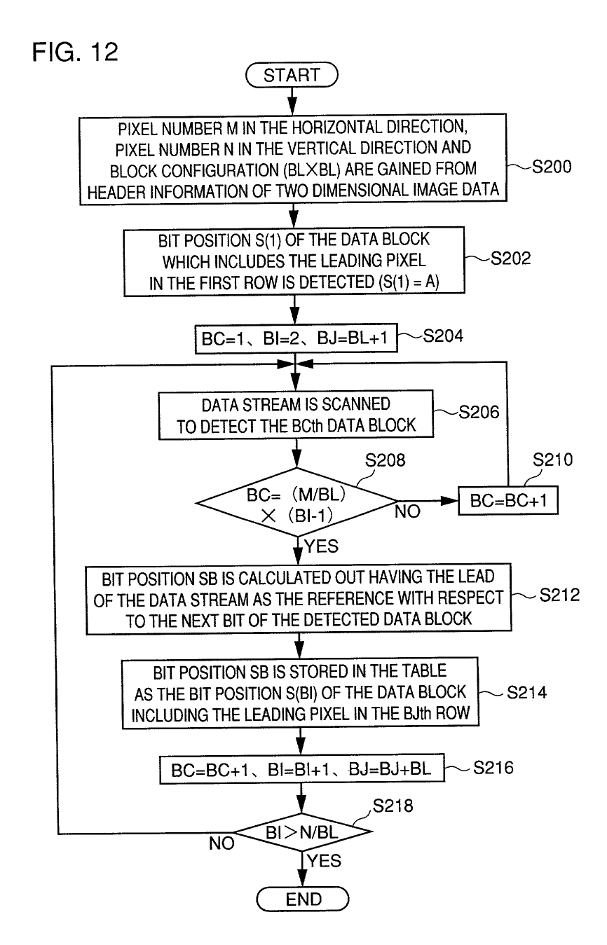

Referring to FIG. 12, the program carried out by the image data conversion device 200 according to the present embodiment has the following control structure with respect to the position detection process of the data blocks of the leading pixel for each row.

At S200, the position detection unit 206 gains the pixel number M in the horizontal direction, the pixel number N in the vertical direction and the block configuration (BL * BL) from the header information of the image data representing a two dimensional image as shown in FIG. 11. Here, the pixel number M in the horizontal direction corresponds to the column number data as shown in FIG. 11, the pixel number N in the vertical direction corresponds to row number data as shown in FIG. 11 and the block configuration (BL * BL) corresponds to the block configuration as shown in FIG. 10, respectively.

At S202, the position detection unit 206 detects the bit position S(1) of the data block which includes the leading pixel of the first row with the lead of variable length code data as a reference. For example, in the case that the data length of the header as shown in FIG. 11 is A bits S(1)=A.

At S204, the position detection unit 206 initializes the variables BC, BI and BJ, respectively (BC=1, BI=2, and BJ=BL+1). Here, the variable BJ indicates row number of the leading pixel included in the data block. For example, in the case the case of a data block of 8 pixels * 8 pixels, that is to say, the pixel number 320 in the vertical direction (BL=8), BJ=1, 9, 17, 25, . . . , 313.

At S206, the position detection unit 206 scans variable length code data stored in the input line memory 204 so as to detect the BCth data block. At S208, the position detection unit 206 determines whether or not BC={(M/BL) * (BI−1)}. In the case that the variable BC is {(M/BL) * (BI −1)} (YES at S208), the process moves to 212. On the other hand, in the case that the variable BC is not the above described value (NO at S208) the process moves to 210.

At S210 the position detection unit 206 carries out an operation of BC=BC+1 with respect to the variable BC. After that the process moves to S206 so as to detect the next data block.

At S212, the position detection unit 206 calculates out the bit position SB with the lead of variable length code data as the reference with respect to the next bit of the detected {(M/BL) * (BI−1)}th data block.

At S214, the position detection unit 206 stores the bit position SB calculated out at S212 in a table as the bit position S(BI) of the data block which includes the leading pixel of the BJth row.

At S216, the position detection unit 206 carries out operations of BC =BC+1 for the variable BC, BI=BI+1 for the variable BI and BJ=BJ+BL for the variable BJ, respectively.

At S218, the position detection unit 206 determines whether or not BI>(N/BL) for the variable BI. In the case that the variable BI is larger than the value gained by dividing the pixel number N in the vertical direction by the block number BL (YES at S218), the process is completed. On the other hand, in the case that the variable BI is the above described value or less (NO at S218), the process returns to S206. After the process returns to S206, variable length code data are further scanned so as to detect the bit position of the data block which includes the leading pixel of the row of BL lines (8 lines) ahead.

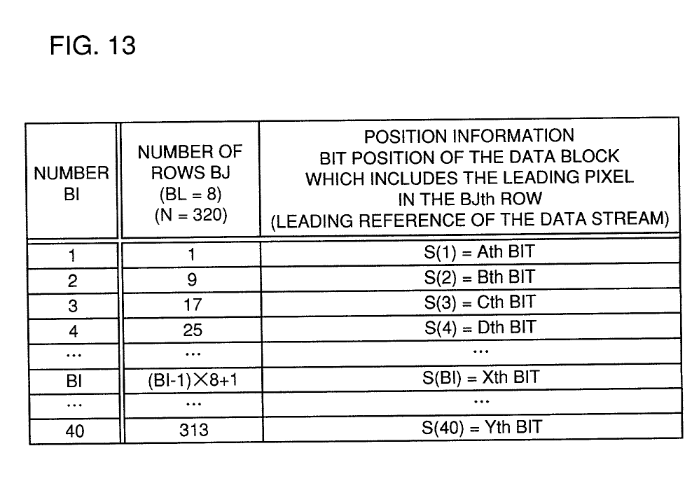

By carrying out such processes for every data block in the vertical direction, the data indicating the position of the data block which includes the leading pixel for each row as shown in FIG. 13 is generated and is stored in the position storing table 208. FIG. 13 shows the data stored in the position storing table 208 in the case of BL=8 and N=320. For example, the data block which includes the leading data of the 25th row is indicated to be included in the data from the Dth bit with the lead of variable length code data as the reference.

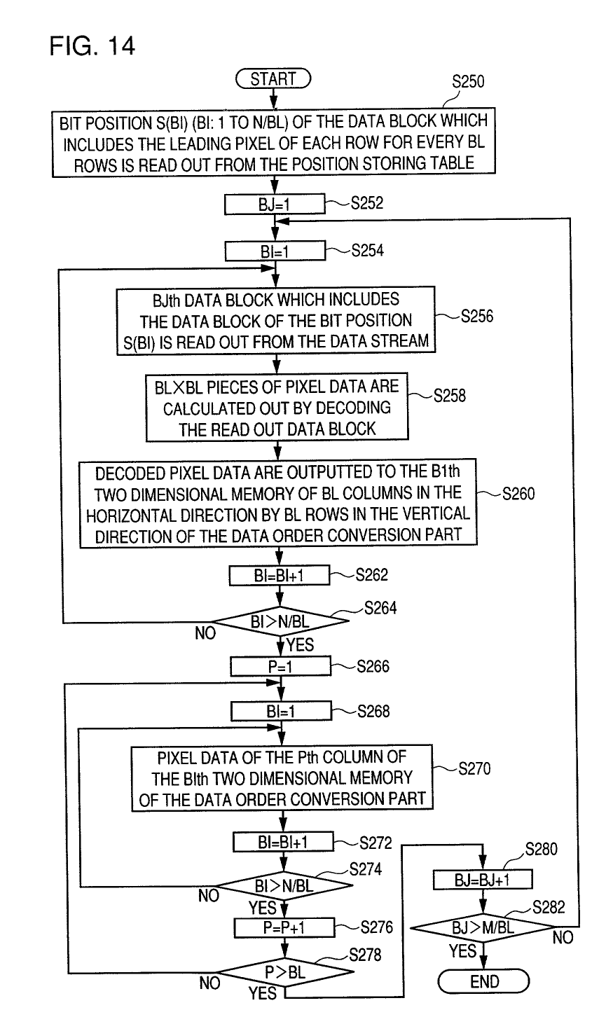

Referring to FIG. 14, the program carried out by the image data conversion device 200, according to the present embodiment, relates to the image data decoding process which has a control structure as follows.

At S250, the control unit 220 reads out, from the position storing table 208, the bit position S(BI) of the data block which includes the leading pixel of each row for every BL rows. In this case the variable BI takes the value of 1 to (N/BL).

At S252, the control unit 220 initializes the variable BJ (BJ=1). At S254, the control unit 220 initializes the variable BI (BI=1).

At S256, the control unit 220 reads out the BJth data block, from the data block of the bit position S(BI), inclusive of this data block, from variable length code data stored in the input line memory 204. The data read out is transmitted to the decoding unit 210.

At S258, the control unit 220 decodes the data block read out to the decoding unit 210 so as to indicate that (BL * BL) pieces of pixel data are calculated out. At S260, the control unit 220 indicates the data decoding unit 210 so that the pixel data decoded by the data decoding unit 210 at S258 are outputted to the BIth two dimensional memory in the data order conversion unit 212.

At S262, the control unit 220 carries out an operation of BI=BI+1 for the variable BI. At S264, the control unit 220 determines whether or not BI>(N/BL). In the case that the variable BI is larger than the value gained by dividing the pixel number N in the vertical direction by the block pixel number BL (YES at S264) the process moves to S266. On the other hand, in the case that the variable BI is the above described value or less (NO at S264) the process moves to S256 so as to carry out a decoding process for the next data block in the same data block column.

At S266, the control unit 220 initializes the variable P (P=1). At S268, the control unit 220 initializes the variable BI (BI=1).

At S270, the control unit 220 outputs, to the output line memory 214, the image data in the Pth column of BIth two dimensional memory of the data order conversion unit 212.

At S272, the control unit 220 carries out an operation of BI=BI+1 for the variable BI. At S274, the control unit 220 determines whether or not BI>(N/BL). In the case that the variable BI is larger than the value gained by dividing the pixel number N in the vertical direction by the block pixel number BL (YES at S274), the process moves to S276. On the other hand, in the case that the variable BI is the above described value or less (NO at S274), the process returns to S270 so as to indicate that the image data of the same column of the next data block are outputted to the output line memory 214.

At S276, the control unit 220 carries out an operation of P=P+1 for the variable P. At S278, the control unit 220 determines whether or not P >BL. In the case that the variable P is larger than the pixel block number BL (YES at S278), the process moves to S280. On the other hand, in the case that the variable P is the block pixel number BL or less (NO at S278) the process returns to S268 so as to indicate that the pixel data of the next column are outputted to the output line memory 214.

At S280, the control unit 220 carries out an operation of BJ=BJ+1 for the variable BJ. At S282, the control unit 220 determines whether or not BJ>(M/BL). In the case that the variable BJ is larger than the value gained by dividing the pixel number M in the horizontal direction by the block pixel number BL (YES at S282), the process is completed. On the other hand, in the case that the variable BJ is the above described value or less (NO at S282), the process returns to S254 so as to carry out a decoding process by the decoding unit 210 and an output process to the output line memory 214 by the data order conversion unit 212 with respect to the next data block column.

The operation of the image data conversion device according to the present embodiment is described based on the above described structure and flow chart.

[Data Block Position Detection Operation]

When the compressed image data are stored in the input line memory 204 via the input interface 102, the pixel number M in the horizontal direction, the pixel number N in the vertical direction and the block configuration (BL * BL) are gained from the header information of the image data representing a two dimensional image as shown in FIG. 11 (S200). At this time, the capacity of the header is assumed to be A bits.

The bit position S(1) of the data block, including the leading pixel of the first row (the first block as shown in FIG. 11), is calculated out. Each variable is initialized, respectively, (S204), and variable length code data stored in the input line memory 204 are scanned so that the data block is detected (S206). In the case that the detected data block is the {(M/BL) * (BI−1)}th data block (YES at S208), the bit position SB is calculated out with the leading position of variable length code data as the reference with respect to the next bit of the detected data block (S212). The bit position SB which has been calculated out is stored in the table as a bit position S(BI) of the data block which includes the leading pixel of each row (S214). In this manner, data of the position storing table 208, as shown in FIG. 13, are generated.

[Data Decoding Operation]

After the data block position detection operation the bit position S(BI) (BI is 1 to (N/BL)) of the data block which includes the leading pixel of each row for every BL rows is read out from the position storing table as shown in FIG. 13 (S250). After each of the variables is initialized, respectively, (S252 and S254), the data block of the first column having the position of the data block of the bit position S(1) as the reference are read out from variable length code data stored in the input line memory 204 (S256). At this time, data of the specific position in the input line memory 204 are read out based on the position information of the position storing table 208. The read out variable length code data are decoded by the decoding unit 210 (S258), and the decoded pixel data are outputted to the two dimensional memory of the data order conversion unit 212 (S260). Next, the data block of the first column having the position of the data block of the bit position S(2) as the reference and the data block of the first column having the position of the data block of the bit position S(3) as the reference are read out in sequence so as to be processed for decoding.

Such processes are carried out until the variable BI exceeds (N/BL) (YES at S264) and, then, the decoding with respect to the first column of the data block is completed so that the pixel data corresponding to that data block column are stored in (N/BL) two dimensional memories of the data order conversion unit 212.

After each of the variables is initialized, respectively, (S266 and S268), the image data of the first column of the first two dimensional memory of the data order conversion unit 212 are outputted to the output line memory 214. Furthermore, the image data of the first column of the two dimensional memories from the second to the (N/BL)th are outputted to the output line memory 214.

In the same manner, the pixel data from the second column to the BLth column of the (N/BL) two dimensional memories are outputted to the output line memory 214, which is repeated. Thereby, the decoded data are outputted to one piece of output line memory 214 with respect to the data block of the first column.

Next, the data block of the second column with the position of the data block of the bit position S(1) as the reference, the data block of the second column with the position of the data block of the bit position S(2) as the reference and the data block of the second column with the position of the data block of the bit position S(3) as the reference are read out in sequence so as to be processed for decoding. Such processes are carried out until the variable BI exceeds (N/BL) (YES at S264) and, thereby, the decoding with respect to the second data block column is completed and the pixel data corresponding to that data block column are stored in the (N/BL) two dimensional memories of the data order conversion unit 212.

Again, after each of the variables is initialized, respectively, (S266 and S268), the image data of the first column of the two dimensional memories from the first to the (N/BL)th of the data order conversion unit 212 are outputted to one line of output line memory 214. In the same manner, the pixel data of the (N/BL) two dimensional memories from the second column to the BLth column are, repeatedly, outputted to the output line memory 214.

Such processes are repeated a predetermined number of times and, thereby, the decoded data are outputted to one line of output line memory 214.

As described above, the image data conversion device according to the present invention can convert the image data compressed through the JPEG system, or the like, into a different order from the order of the inputted pixel data so as to be outputted to a device such as a printer. As a result, the position at which each pixel is stored is not required to be stored in the compressed image data and an image data conversion device which does not require a large capacity of frame memory and which can convert the arrangement of pixels included in the compressed image data so as to be outputted can be provided.

### Third Embodiment

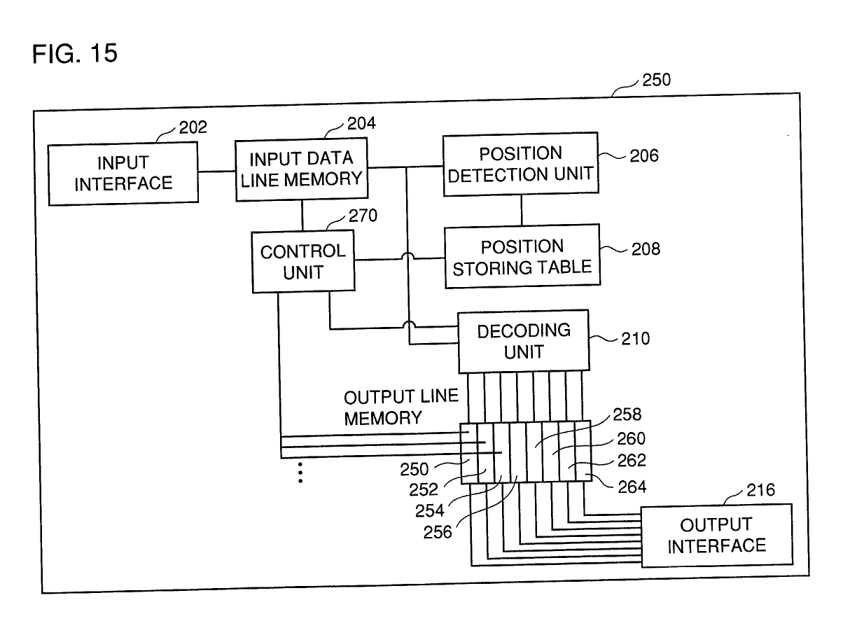

Referring to FIG. 15, an image data conversion device 250 according to the present embodiment includes a control unit 270, instead of the control unit 220 in the image data conversion device 200 of the Second Embodiment as shown in FIG. 8, output line memories 250 to 264, instead of the output line memory 214 in the image data conversion device 200 of the Second Embodiment as shown in FIG. 8, and an output interface 216, instead of the output interface 110 in the image data conversion device 200 of the Second Embodiment as shown in FIG. 8, respectively. Here, the other parts of the structure are the same as those in the Second Embodiment as shown in FIG. 8 and, therefore, the detailed description thereof will not be repeated here.

The control unit 270 reads out variable length code data, from a predetermined position of the input line memory 204 based on the position information stored in the position storing table 208, so as to make the data decoding unit 210 process the variable length code data for decoding. The control unit 270 is connected to the output line memories 250 to 260, respectively, and controls the storage of the image data, decoded by the data decoding unit 210 in a predetermined line memory, or the output of the image data, from a predetermined line memory to the output interface 216. The output interface 216 is connected to the output line memories 250 to 264, respectively, and receives the decoded pixel data via the output line memories. Here, in the case that the number of block pixels is (BL * BL), the number of the output line memory becomes BL while the number of the input ports for the output interface 216 becomes BL. An apparatus connected to the output interface 216 is a printer which can print out the data for BL columns in parallel, or the like. Variable length code data which has been compressed by a unit of a block of 8 pixels * 8 pixels are inputted into the image data decoding device 250 as shown in FIG. 15 and, therefore, the number of the output line memories becomes 8.

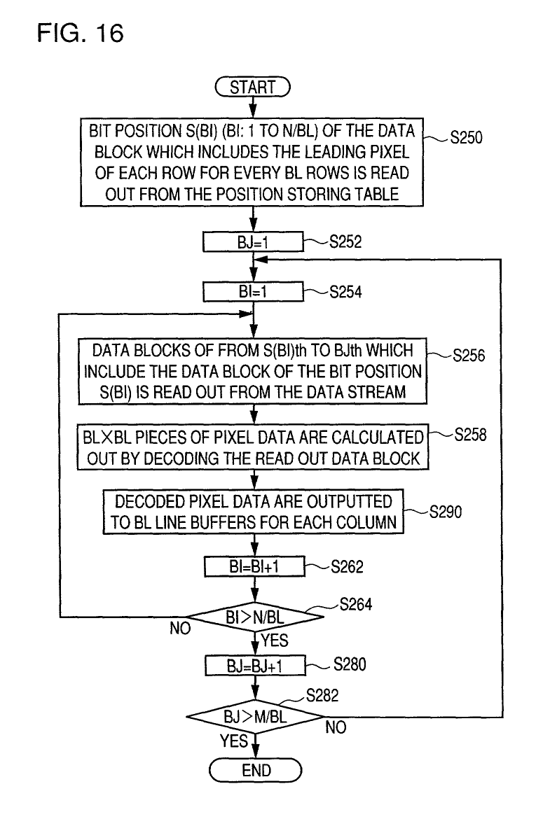

Referring to FIG. 16, the program which is carried out in the image data conversion device 250 according to the present embodiment has the following control structure with respect to the data decoding process. Here, the data block position detection process is the same as that of the process in the above described Second Embodiment and, therefore, the detailed description thereof will not be repeated here. In addition, in the flow chart in FIG. 16 the same processes as those in FIG. 14 have the same step numbers attached thereto. The processes for these are the same and, therefore, the detailed description thereof will not be repeated here.

Referring to FIG. 16, after the processes at S250 to S256, the control unit 270 decodes, at S258, to the variable length code decoding unit 210 the variable length code data which has been read out at S256 from the input line memory 204 so as to indicate that (BL * BL) pieces of image data are calculated out.

At S290, the control unit 270 allocates the image data which have been decoded in the data decoding unit 210 at S258 into BL output line memories 250 to 264 for each column of the image data so as to be outputted. Such processes are carried out repeatedly for every data block row for each data block column so that the decoded image data are outputted to BL output line memories 250 to 264.

In this manner, the (BL * BL) pieces of image data which have been decoded by the decoding unit 210 are allocated to the BL output line memories 250 to 264 for each column so as to be outputted. The decoded image data are outputted from the output line memories 250 to 264 to the output interface 216 so as to be outputted to a printer, or the like, wherein data in BL columns are possible to be processed, in parallel, from the output interface 216.

As described above, the image data conversion device according to the present embodiment can convert the arrangement of pixels included in the compressed image data so as to be outputted without receiving stored positions of respective pixels for the compressed image data and without requiring a large capacity of the memory.

### Fourth Embodiment

An image data conversion device according to the present invention includes another position detection part which is different from the position detection unit 206 as shown in FIG. 8. Other parts of the structure are the same as those in the Second Embodiment, the detailed description of which will not be repeated here.

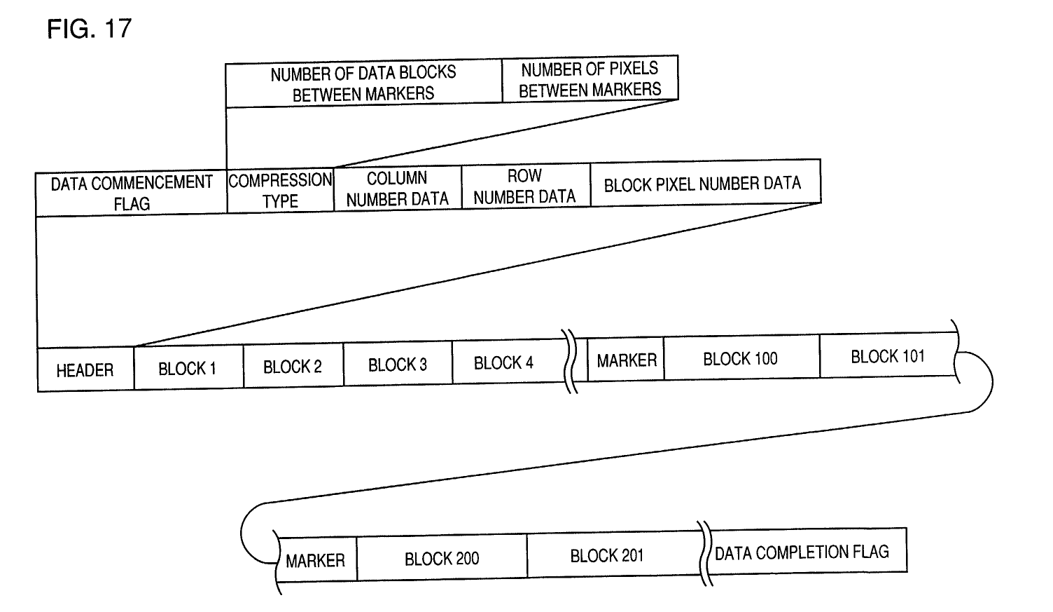

Referring to FIG. 17, markers are inserted for a specific number of data blocks in image data stored in the input line memory 204 of the image data conversion device according to the present embodiment. As shown in FIG. 17, those compressed image data include the header, the first block which is variable length code data for each data block, the second block, the third block, the fourth block, . . . , a marker, the one hundredth block, the one hundred first block, . . . , a marker, the two hundredth block, the two hundred first block, . . . , and the data completion flag. The header includes a data commencement flag, a compression system, column number data, row number data and block pixel number data. The data which represents a compression system included in the header includes the number of data blocks between markers and the number of pixels between markers. Markers are inserted into the image data as shown in FIG. 17 for every number of data blocks between markers. Those markers are referred to as restart markers in the JPEG system. In these compression image data, the commencement position of the header is assumed to be 0 bits.

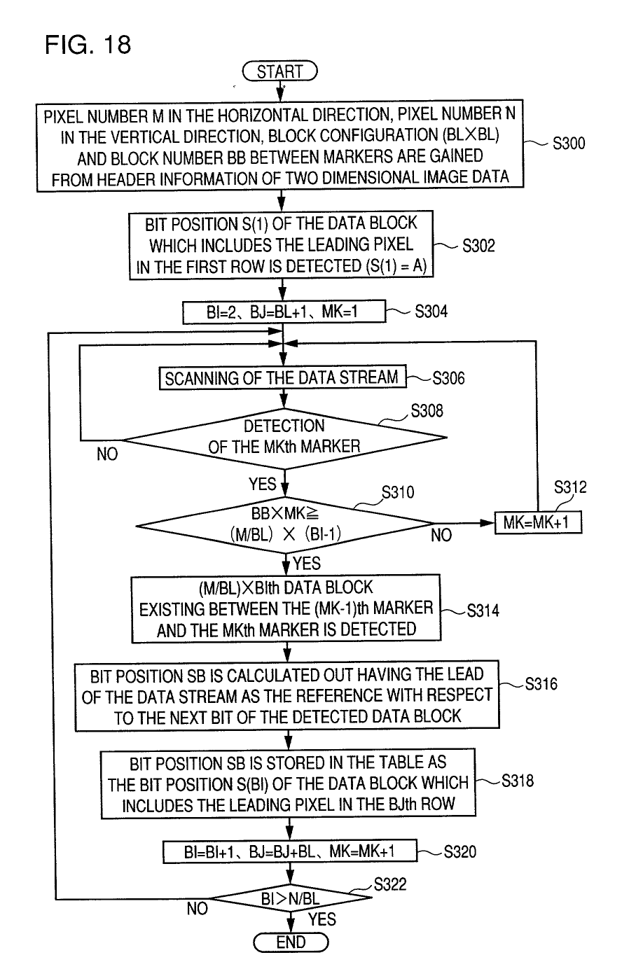

Referring to FIG. 18, the image data conversion device according to the present invention has the following control structure with respect to the data block position detection process.

At S300, the position detection unit gains the pixel number M in the horizontal direction, the pixel number N in the vertical direction, the block structure (BL * BL) and the block number between markers BB.

At S302 the position detection unit detects the bit position S(1) with the lead of variable length code data as the reference with respect to the data block which includes the leading pixel in the first row. In the case that the data length of the header as shown in FIG. 17 is A, S(1)=A.

At S304, the position detection unit initializes the variables BI, BJ and MK, respectively, (BI=2, BJ=BL+1 and MK=1).

At S306 the position detection unit scans the variable length code data stored in the input line memory 204. At S308 it is determined whether or not the MKth marker of the position detection part is detected. When the MKth marker is detected (YES at S308) the process moves to S310. On the other hand, when the MKth marker is not detected (NO at S308) the process returns to S306 and the variable length code data are scanned so as to detect the marker.

At S310, the position detection unit determines whether or not (BB * MK)≧{(M/BL) * (BI−1)}. In the case that that (BB * MK) is {(M/BL) * (BI −1)} or more (YES at S310), the process moves to S314. On the other hand, BB * MK is smaller than the above described value (NO at S310), the process moves to S312. At S312 the position detection unit carries out an operation of MK=MK+1 for the variable MK. After that the process moves to S306.

At S314, the position detection unit detects the {(M/BL) * BI}th data block existing between the (MK−1)th marker and the MKth marker.

At S316, the position detection unit calculates out the bit position SB with the lead of the variable length code data as the reference with respect to the bit next to the data block detected at S314.

At S318, the position detection unit stores the bit position SB calculated out at S316 in the table as a bit position S(BI) of the data block which includes the leading pixel in the BJth row.

At S320, the position detection unit carries out an operation of BI=BI+1 for the variable BI, BJ=BJ+BL for the variable BJ and MK=MK +1 for the variable MK. At S322, the position detection unit determines whether or not BI>(N/BL). In the case that the variable BI is larger than the value gained by dividing the pixel number N in the vertical direction by the block pixel number BL (YES at S322), the process is completed. On the other hand, in the case that the variable BJ is the above described value or less (NO at S322), the process returns to S306. After returning to S306, the variable length code data are further scanned so as to detect the bit position of the data block which includes the leading pixel in the BL rows ahead (8 rows ahead).

Here, the data recording process in the image data conversion device with respect to the present embodiment is the same as that of the above described Third Embodiment,,the detailed description of which will not be repeated here.

The operation of the image data conversion device according to the present embodiment is described based on the above described structure and flow chart.

When the image data as shown in FIG. 17 are stored in the input line memory 204 via the input interface 202, the pixel number M in the horizontal direction, the pixel number N in the vertical direction, the block structure (BL * BL) and the block number BB between markers are gained from the header information of the image data (S300). The bit position S(1) of the data block which includes the leading pixel in the first row is detected (S302), each variable is, respectively, initialized (S304) and, after that, the variable length code data stored in the input line memory 200 are scanned (S306).

When a marker is detected in the process of scanning the variable length code data (YES at S308), whether or not (BB * MK)≧{(M/BL) * (BI−1)} is determined (S310). In the case that (BB * MK) is the above described value or more (YES at S310), the {(M/BL) * BI}th data block existing between the (MK−1)th and the MKth markers is detected (S314).

The bit position SB is calculated out with the lead of the variable length code data with respect to the bit next to the detected data block as the reference (S316), and the calculated out bit position SB is stored in the table as the bit position S(BL) of the data block which includes the leading pixel in the BJth row (S318).

Such a process is repeatedly carried out until the variable BI exceeds (N/BL) (YES at S322). By repeating such an operation, position information is stored in the data table as shown in FIG. 13.

As described above, the image data conversion device according to the present embodiment cannot detect the position of the data block which includes the leading pixel of each row by using markers included in the compressed image data. As a result, an image data conversion device which can convert the arrangement of pixels included in the input compressed image data so as to be outputted without receiving the memory position of each pixel in the image data and without requiring a large capacity of the frame memory can be provided.

### Fifth Embodiment

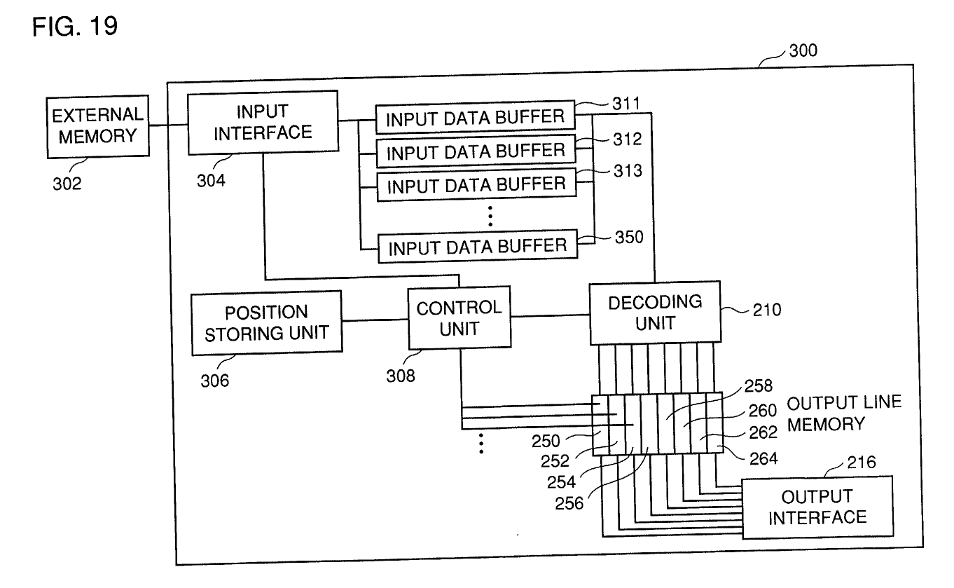

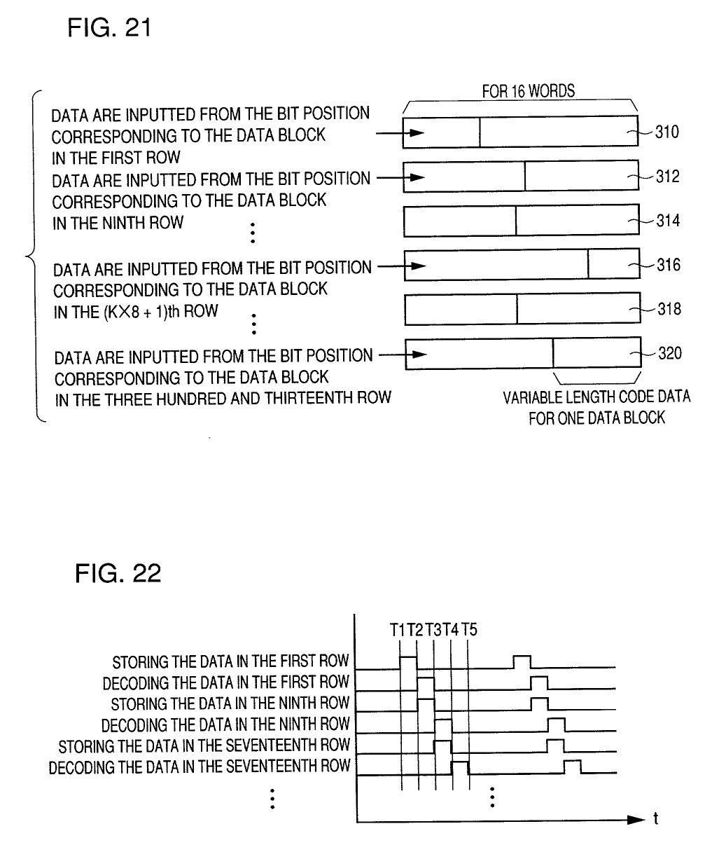

Referring to FIG. 19, an image data conversion device 300 according to the present embodiment includes an input interface 304 connected to an external memory 302 for inputting variable length code data stored in the external memory 302 to an input data buffer as described below, a position memory unit 306 for storing position information indicating the position of the data block which includes the leading pixel of each row in the image data received from the external memory 302, a control unit 308 connected to the input interface 304 and a position memory unit 306 for controlling the entirety of this image data conversion device 300, a plurality of input data buffers 311 to 350 connected, respectively, to the input interface 304 for memorizing variable length code data received via the input interface 304, a data decoding unit 210, output line memories 250 to 264 and an output interface 216. Here, the data decoding unit 210, the output line memories 250 to 264 and the output interface 216 are, respectively, the same as the corresponding structures in the third embodiment, the detailed description of which will not be repeated here. Moreover, the number of input data buffers is defined by the pixel number N in the vertical direction and the block pixel number BL, which becomes (N/BL). In the case that the pixel number in the vertical direction N=320 and the block pixel number BL=8, the number of the input data buffers becomes 40 as shown in FIG. 21. The input data buffers 311 to 350 are data buffers of the first in first out type which have, respectively, the same structure. Each of the input data buffers has a memory capacity for 16 words which can store at least one data block.

The external memory 302 is a memory with slow operation speed, such as a memory card for a digital camera. An input interface 304 stores image data received from the external memory 302 in a predetermined input buffer based on a control signal from the control unit 308.

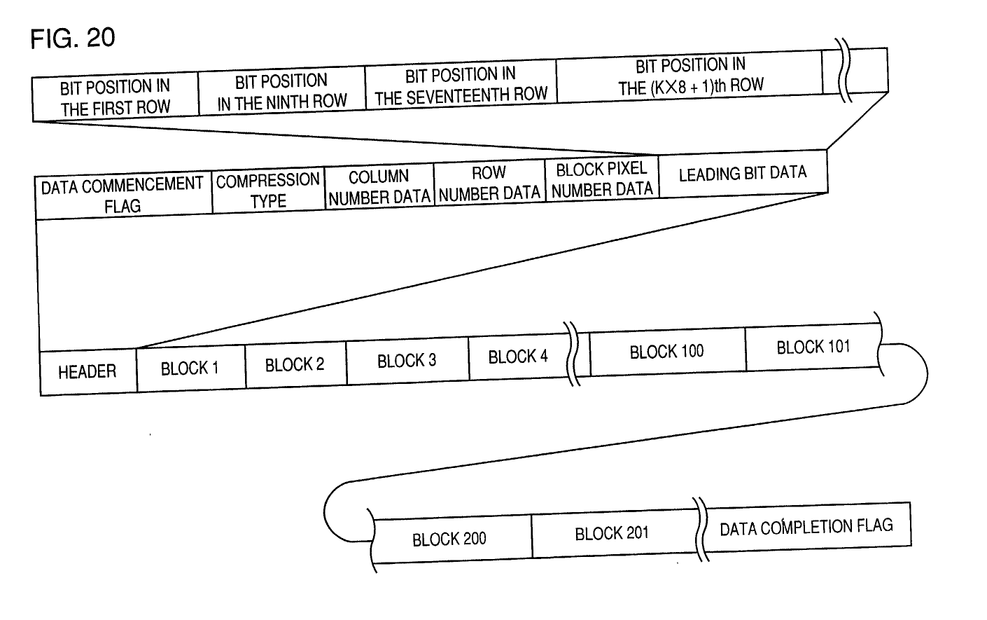

Referring to FIG. 20, variable length code data received via the input interface 304 includes the header, the first block, which is variable length code data for each data block, the second block, the third block, the fourth block, . . . , the hundredth block, the hundred first block, . . . , the two hundredth block, the two hundred first block, . . . , and the data completion flag. The header includes the data commencement flag, the data representing compression type, column number data, row number data, block pixel number data and the leading bit data which include the leading pixels for respective rows. The leading bit data includes the bit position in the first row, the bit position in the ninth row, the bit position in the seventeen row, . . . , the bit position in the (K * 8+1)th row (K=1, 2, 3, . . . , 39).

Referring to FIG. 21, in the input data buffer 310 to 350, variable length code data, which correspond to the data blocks in the first row, the ninth row, . . . , the (K * 8+1)th row . . . , and the three hundred thirteenth row (K=1, 2, 3, . . . , 39) are, respectively, inputted. For example, the variable length code data corresponding to the data block in the three hundred thirteenth row are inputted in the input data buffer 320. A control signal from the control unit 308 allows variable length code data for one data block to be sent out in sequence to the decoding unit 210 from the input data buffer 320. In the case that the variable length code data for one data block are sent out to the decoding unit 210, the next variable length code data for the capacity of the sent out variable length code data are inputted in the input data buffer 320. Such a process is repeatedly carried out.

The operations of the input data buffers 311 to 350 and the data decoding unit 210 in the image data conversion device 300 according to the present embodiment based on the above described structures are described below.

Referring to FIG. 22, the data in the first row are stored in the input data buffer 310 by the control signal from the control unit 308 (T1 to T2). The variable length code data for one data block in the first row, which has been stored in the input data buffer 310, are sent out to the decoding unit 210 by the control signal from the control unit 308 so as to be decoded (T2 to T3).

Parallel to the operation of decoding the variable length code data in the first row at the decoding unit 210, the data in the ninth row are stored in the input data buffer 312 based on the control signal from the control unit 308 (T2 to T3). Based on the control signal from the control unit 308, the data in the ninth row, which have been stored in the input data buffer 312, are sent out to the decoding unit 210 so as to be decoded (T3 to T4).

Parallel to the operation of decoding the data in the ninth row at the decoding unit 210, the data in the seventeenth row are stored in the input data buffer 314 (T3 to T4).

Such operations are repeatedly carried out. By carrying out, in parallel, the operation of decoding the data in the first row and the operation of storing the data in the ninth row, the entire operation time can be shortened.

As described above, the image data conversion device according to the present embodiment can carry out the storage of data and the decoding of data in parallel by arranging, in parallel, the input data buffers of first in first out type which have a small data capacity. As a result, an image data conversion device of which the operation speed is fast can be provided.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image data conversion device which converts image data comprising pixels of M columns (M is a positive integer) in the horizontal direction by N rows (N is a positive integer) in the vertical direction, wherein said image data are first one dimensional data gained by repeating pixels for M columns, which continue in the horizontal direction, N times in sequence in the vertical direction, said image data conversion device including:
a line memory which stores said first one dimensional data;
a detection circuit which is connected to said line memory and which detects the number M of pixels in the horizontal direction of said first one dimensional data which are stored in said line memory; and
a conversion circuit which is connected to said line memory and said detection circuit and which reads out, in the order related to said M and, thereby, converts each pixel of said first one dimensional data stored in said line memory into a second one dimensional data.

2. The image data conversion device according to claim 1 wherein said image data includes data representing the pixel number M in the horizontal direction, and said detection circuit includes a circuit which reads out data representing the pixel number M in the horizontal direction from said first one dimensional data.

3. The image data conversion device according to claim 1 wherein said conversion circuit includes a circuit which reads out each pixel of said first one dimensional data in the order in accordance with a multiple of said M.

4. The image data conversion device according to claim 1, wherein said conversion circuit is connected to said line memory and said detection circuit, and which further includes:
a circuit which reads out a plurality of pixels existing in positions defined based on said M having predetermined pixel positions, in said first one dimensional data stored in said line memory, as the reference from said first one dimensional data in sequence; and
a circuit which carries out, repeatedly, a process of converting said predetermined pixel positions according to a predetermined order so as to be read out in sequence.

5. The image data conversion device according to claim 4 wherein a position defined based on said M is the position, located a multiple of said M apart, having a predetermined position of a pixel as the reference.

6. The image data conversion device according to claim 4 wherein said plurality of pixels are N pixels.

7. An image data conversion device which converts image data comprising pixels of M columns (M is a positive integer) in the horizontal direction by N rows (N is a positive integer) in the vertical direction, wherein said pixels are divided into data blocks of M/P columns (P is a positive integer and P is a divisor of M) in the horizontal direction and N/R rows (R is a positive integer and R is a divisor of N) in the vertical direction; and pixel data included in said divided data blocks are compressed into variable length code data; said image data are first one dimensional data which include a plurality of pieces of said variable length code data, data representing the number M of pixels in the horizontal direction and data representing the number P of pixels in the horizontal direction of said data blocks; said variable length code data are arranged in the order corresponding to the order of the data blocks when the data blocks are arranged in the line-sequential prioritizing the rows, said image data conversion device including:
a detection circuit for detecting data representing the number M of pixels in the horizontal direction and data representing the number P of pixels in the horizontal direction of said data blocks from said first one dimensional data;
a decoding circuit which is connected to said detection circuit and which reads out variable length code data, corresponding to a plurality of data blocks existing in the positions defined based on said (M/P) having a predetermined data block in said first one dimensional data as the reference, from said first one dimensional data in sequence so as to be decoded;
an output circuit which is connected to said decoding circuit and which outputs, in sequence, pixels for one column in the vertical direction which are decoded by said decoding circuit; and
a control circuit which is connected to said decoding circuit and which makes said decoding circuit carry out repeatedly the process of converting the positions of said predetermined data blocks in accordance with a preset order so as to read out said variable length code data.

8. The image data conversion device according to claim 7 wherein a position defined based on said (M/P) is the position located a multiple of said (M/P) apart having a predetermined data block as the reference.

9. The image data conversion device according to claim 7 wherein:
said decoding circuit includes a circuit which reads out, (N/R) times, variable length code data which corresponds to a plurality of data blocks existing in the positions located a multiple of said (M/P) apart having a predetermined data block in said first one dimensional data as the reference from said first one dimensional data so as to be decoded; and
said control circuit includes a circuit which makes said decoding circuit repeatedly carry out a process of changing, (M/P) times, the positions of said predetermined data blocks one by one so as to read out said variable length code data.

10. The image data conversion device according to claim 7 wherein:
said image data further include markers provided for a constant number of data blocks; and
said decoding circuit includes a circuit for specifying said predetermined data blocks by using said markers.

11. The image data conversion device according to claim 7 wherein:
said first one dimensional data further include position information representing positions of (N/R) data blocks which include leading data of each row for every R rows in said first one dimensional data;
the detection circuit includes a circuit for detecting said position information; and
said data conversion device further includes:
(N/R) buffers, each of said (N/R) buffers having a capacity for storing variable length code data corresponding to at least one data block; and
a buffer control circuit which is connected to each of said (N/R) buffers and said decoding circuit and which controls said buffer and said decoding circuit so as to read out variable length code data, corresponding to the data blocks continuing in the vertical direction, based on said position information from said one dimensional data in order to be stored in one buffer among said (N/R) buffers corresponding to said read out variable length code data and at the same time carries out repeatedly a process of transferring variable length code data which have been stored in another buffer to said decoding circuit.

12. The image data conversion device according to claim 7 wherein said output circuit includes a circuit which outputs, in parallel, pixels for P columns in the vertical direction which have been decoded by said decoding circuit.

13. The image data conversion device according to claim 12 wherein a position defined based on said (M/P) is the position located a multiple of said (M/P) apart having a predetermined data block as the reference.

14. The image data conversion device according to claim 12 wherein:
said decoding circuit includes a circuit which reads out, (N/R) times, variable length code data which corresponds to a plurality of data blocks existing in the positions located a multiple of said (M/P) apart having a predetermined data block in said first one dimensional data as the reference from said first one dimensional data so as to be decoded; and
said control circuit includes a circuit which makes said decoding circuit repeatedly carry out a process of changing, (M/P) times, the positions of said predetermined data blocks one by one so as to read out said variable length code data.

15. The image data conversion device according to claim 12 wherein:
said image data further includes markers provided for a constant number of data blocks; and
said decoding circuit includes a circuit which specifies said predetermined data block by using said markers.

16. The image data conversion device according to claim 12 wherein:
said first one dimensional data further include position information representing the positions of (N/R) data blocks which include leading data of respective rows for every R rows is said first one dimensional data;
said detection circuit includes a circuit which detects said position information;
said data conversion device further includes
(NMR) buffers, each of said (N/R) buffers having a capacity for storing variable length code data corresponding to, at least, one data block and,
a buffer control circuit connected to each of said (N/R) buffers as well as to said decoding circuit which carries out, repeatedly, a process of control of said buffer and said decoding circuit so as to read out variable length code data corresponding to data blocks continuing in the vertical direction from said one dimensional data based on said position information so as to be stored in one buffer among said (N/R) buffers corresponding to said variable length code data which have been read out and, at the same time, a process of transfer of variable length code data which have been stored in another buffer to said decoding circuit.

17. An image data conversion method for converting image data comprising pixels of M columns (M is a positive integer) in the horizontal direction by N rows (N is a positive integer) in the vertical direction, wherein: said pixels are divided into data blocks of M/P columns (P is a positive integer and P is a divisor of M) in the horizontal direction and N/R rows (R is a positive integer and R is a divisor of N) in the vertical direction and pixel data included in said divided data blocks are compressed into variable length code data; said image data are first one dimensional data which include a plurality of pieces of said variable length code data, data representing the number M of pixels in the horizontal direction and data representing the number P of pixels in the horizontal direction of said data blocks; and said variable length code data are arranged in the order corresponding to the order of data blocks when the data blocks are arranged in the line order prioritizing rows, said image data conversion method including the steps of:
detecting data representing the number M of pixels in the horizontal direction and the data representing the number P of pixels in the horizontal direction of said data blocks from said first one dimensional data;
reading out, in sequence, variable length code data, corresponding to a plurality of data blocks which exist at the positions defined based on said (M/P) having a predetermined data block as the reference in said first one dimensional data, from said first one dimensional data so as to be decoded;
outputting, in sequence, pixels for one column in the vertical direction decoded in said step of decoding variable length code data;
decoding said variable length code data while converting the positions of said predetermined data blocks according to a preset order; and
repeating said step of outputting.

18. The image data conversion method according to claim 17 wherein:
said decoding step includes a step of reading out, (N/R) times, variable length code data, corresponding to a plurality of data blocks existing in the positions located a multiple of said (M/P) apart having a predetermined data block in said first one dimensional data as the reference, from said first one dimensional data so as to be decoded; and
said repeating step includes a step of repeating the step of decoding and the step of output of said variable length code data while converting, (M/P) times, said positions of the predetermined data blocks one by one.

19. The image data conversion method according to claim 17 wherein said step of output includes a step of outputting, in parallel, pixels for P columns in the vertical direction which have been decoded in said step of decoding.

20. The image data conversion method according to claim 19 wherein:
said step of decoding includes a step of reading out, (N/R) times, variable length code data, corresponding to a plurality of data blocks existing in the positions located a multiple of said (M/P) apart having predetermined data blocks in said first one dimensional data as the reference, from said first one dimensional data so as to be decoded; and
said step of repeating includes a step of repeating the step of decoding and the step of outputting said variable length code data while converting, (M/P) times, said positions of the predetermined data blocks one by one.
